(19) United States
(12) Patent Application Publication
(10) Pub. No.: US 2013/0008184 A1
(43) Pub. Date: Jan. 10, 2013

(54) DISPLACER, MANUFACTURING METHOD THEREOF, AND REGENERATIVE TYPE REFRIGERATOR

(75) Inventors: Takahiro MATSUBARA, Tokyo (JP); Jyunya Hamasaki, Tokyo (JP)

(73) Assignee: SUMITOMO HEAVY INDUSTRIES, LTD., Tokyo (JP)

(21) Appl. No.: 13/616,697

(22) Filed: Sep. 14, 2012

Related U.S. Application Data
(63) Continuation of application No. PCT/JP2011/056362, filed on Mar. 17, 2011.

(30) Foreign Application Priority Data
Mar. 17, 2010 (JP) 2010-060998

(51) Int. Cl. F01B 23/00; B23P 15/10; F25B 9/00

(52) U.S. Cl. 62/6; 92/145; 29/888.04

(57) ABSTRACT

A disclosed displacer to be inserted into a cylinder to expand a compressed working fluid inside the cylinder by reciprocation of the displacer inside the cylinder includes a cylindrical member; and a regenerative material included inside the cylindrical member, wherein a groove is formed on an outer peripheral surface of the cylindrical member, the outer peripheral surface facing the cylinder, and a sealing film is continuously formed on the outer peripheral surface and the groove over an area where the groove is formed in a longitudinal direction.

### CROSS-REFERENCE TO RELATED APPLICATIONS

This application is a U.S. continuation application filed under 35 USC 111a and 365c of PCT application JP2011/056362 filed Mar. 17, 2011, which claims priority to Application No. 2010-060998 filed in Japan on Mar. 17, 2010. The foregoing applications are hereby incorporated by reference in their entirety.

### BACKGROUND OF THE INVENTION

1. Field of the Invention

The present invention generally relates to a displacer, a manufacturing method thereof, and a regenerative type refrigerator. More specifically, the present invention relates to a displacer on which surface a groove is formed, a manufacturing method thereof, and a regenerative type refrigerator using the displacer.

2. Description of the Related Art

An example of a regenerative type refrigerator including a regenerator in which a regenerative material is accommodated and using a refrigerant gas is a Gifford-McMahon (GM) cycle refrigerator (hereinafter, referred to as a GM refrigerator). An exemplary GM refrigerator has a structure in which a displacer in inserted in a cylinder.

An expansion chamber is provided on a low temperature side inside the cylinder and a cavity is provided on a high temperature end. A gas passage is provided inside the displacer. A regenerative material fills the inside of the gas passage. The gas passage inside the displacer communicates with the expansion chamber and a cavity on the side of the high temperature end. The displacer is reciprocated along a longitudinal axis direction of the cylinder by a driving mechanism which is formed by, for example, a motor and a scotch yoke mechanism.

A refrigerant gas supply system is connected to the GM refrigerator. The refrigerant gas supply system supplies a refrigerant gas into the cavity at the high temperature end and recovers the refrigerant gas from the cavity. The supply and recovery of the refrigerant gas are synchronized with reciprocating motion of the displacer. When the refrigerant gas is supplied into the cavity at the high temperature end, the refrigerant gas is introduced into the expansion chamber through the gas passage inside the displacer. The refrigerant gas inside the expansion chamber is recovered by the refrigerant gas supply system via the route for introducing the refrigerant gas.

When the refrigerant gas expands along with the reciprocating motion of the displacer, the refrigerant gas is cooled to generate cold thermal energy. The refrigerant gas having a cryo temperature absorbs heat from the circumference and cools the regenerative material inside the displacer when the refrigerant gas is recovered from the expansion chamber. After the cold heat is exchanged so as to be transferred from the refrigerant gas to the regenerative material, the heated refrigerant gas is ejected from the cylinder. Further, when the refrigerant gas is introduced into an expansion chamber in a subsequent cycle, the refrigerant gas is cooled by the regenerative material in which the cold heat is accumulated. By repeating the above processes, the low temperature side of the cylinder is maintained to be at a cryo temperature.

Further, if a gap between the cylinder and the displacer is not sufficiently sealed, there may be a case where the refrigerant gas cannot produce a predetermined refrigeration capacity. In order to prevent the incapability of the refrigerant gas, the Patent Document 1 discloses an example structure in which a helical groove in formed on an outer peripheral surface of the displacer. With this structure, the refrigerant gas intrudes into the gas passage flowing inside the displacer and a gap between the cylinder and the displacer, and is branched into the refrigerant gas flowing along the helical groove.

Since the refrigerant gas flowing along the helical groove travels a longer route than that of the gas passage along the longitudinal axis of the cylinder, the refrigerant gas can sufficiently exchange the cold heat with the displacer. Therefore, heat loss caused by the refrigerant gas flowing through the gap between the cylinder and the displacer can be reduced to thereby prevent a drop of the refrigeration capacity.

Further, in order to securely introduce the refrigerant gas into the helical groove, it is necessary to firmly seal the gap between an auger of the displacer and the inner wall of the cylinder. The Patent Document 2 discloses an exemplary structure in which a sealing film made of a resin is formed on an outer peripheral surface of the displacer.

FIGS. 1A to 1C illustrate a method of forming a helical groove 138 and a sealing film 139. When the helical groove 138 and the sealing film 139 are formed in the displacer 103, a cylindrical member 130 as a base material as illustrated in FIG. 1A is prepared and the sealing film 139 is coated on a predetermined outer peripheral portion of the cylindrical member 103 as illustrated in FIG. 1B by coating or the like.

Subsequently, as illustrated in FIG. 1C, the cylindrical member 130 formed with the sealing film 139 is mounted on a machining apparatus for processing a helical groove such as a lathe turning machine to thereby cut the helical groove 138.
[Patent Document 1] Japanese Patent No. 2659684
[Patent Document 2] Japanese Laid-open Patent Publication No. 2001-248929

### SUMMARY OF THE INVENTION

According to an aspect of the embodiments of the present invention, there is provided a displacer to be inserted into a cylinder to expand a compressed working fluid inside the cylinder by reciprocation of the displacer inside the cylinder, the displacer including a cylindrical member; and a regenerative material included inside the cylindrical member, wherein a groove is formed on an outer peripheral surface of the cylindrical member, the outer peripheral surface facing the cylinder, and a sealing film is continuously formed on the outer peripheral surface and the groove over an area where the groove is formed in a longitudinal direction.

### BRIEF DESCRIPTION OF DRAWINGS

FIG. 1A illustrates a cylindrical member before applying an exemplary manufacturing method of manufacturing a displacer;

FIG. 1B is a plan view of the cylindrical member provided with a sealing film while applying the exemplary manufacturing method of manufacturing the displacer;

FIG. 1C is a plan view of the cylindrical member in which a groove is cut while applying the exemplary manufacturing method of manufacturing the displacer;

FIG. 2 is a cross-sectional view of a Gifford-McMahon type refrigerator of an embodiment of the present invention;

FIG. 3 is an exploded perspective view of a rotary valve illustrated in FIG. 2;

FIG. 4A is a cross-sectional view of a second stage displacer illustrated in FIG. 2;

FIG. 4B is an enlarged view of a circle indicated by a dot chain line in FIG. 4A;

FIG. 5A is a front view of a cylindrical member before processing for illustrating a manufacturing method of a second stage displacer used in the refrigerator of the embodiment of the present invention;

FIG. 5B is a front view of the cylindrical member in which a groove is cut for illustrating the manufacturing method of the second stage displacer used in the refrigerator of the embodiment of the present invention;

FIG. 5C is a front view of the cylindrical member where the groove is provided with the a sealing film for illustrating the manufacturing method of the second stage displacer used in the refrigerator of the embodiment of the present invention;

FIG. 6A is a cross-sectional view of a second displacer as an modified example; and

FIG. 6B is an enlarged view of a circle indicated by a dot chain line in FIG. 6A.

### DETAILED DESCRIPTION OF THE PREFERRED EMBODIMENTS

A helical groove and a sealing film provided in a displacer are important factors in order to reduce heat loss and improve refrigeration capacity in a GM refrigerator.

Especially, the thickness of a sealing film becomes important in order to firmly seal a gap between the sealing film and an inner wall of a cylinder. If the sealing film is thick on the surface of the displacer, a clearance (a gap) between the sealing film and the inner wall of the cylinder may vary due to a difference of the coefficients of thermal expansion of materials of the sealing film and the cylinder. If this variation of the clearance (the gap) occurs, the refrigerant gas may leak from the clearance (the gap) between the displacer and the cylinder to thereby lower the refrigeration capacity. Therefore, in order to reduce the variation of the clearance (the gap) between the sealing film and the cylinder, it is effective to reduce the film thickness of the sealing film.

However, if the film is simply made thinner, the strength of the sealing film may be lowered. Therefore, the sealing film coated on the cylindrical member 130 may be peeled off the cylindrical member 130 when the helical groove 138 is cut. As described above, if the sealing film 139 is peeled off the cylindrical member 130, the refrigerant gas leaks from the portion to thereby lower the refrigeration capacity.

Accordingly, embodiments of the present invention may provide a novel and useful improved displacer, a manufacturing method thereof and a regenerative type refrigerator.

More specifically, the embodiments of the present invention may provide a displacer from which a sealing film is prevented from being peeled, a manufacturing method thereof, and a regenerative type refrigerator enabling a stable cooling process by an improved sealing performance between the displacer and a cylinder by preventing the sealing film from peeling off the displacer.

An embodiment of the present invention is described with reference to figures.

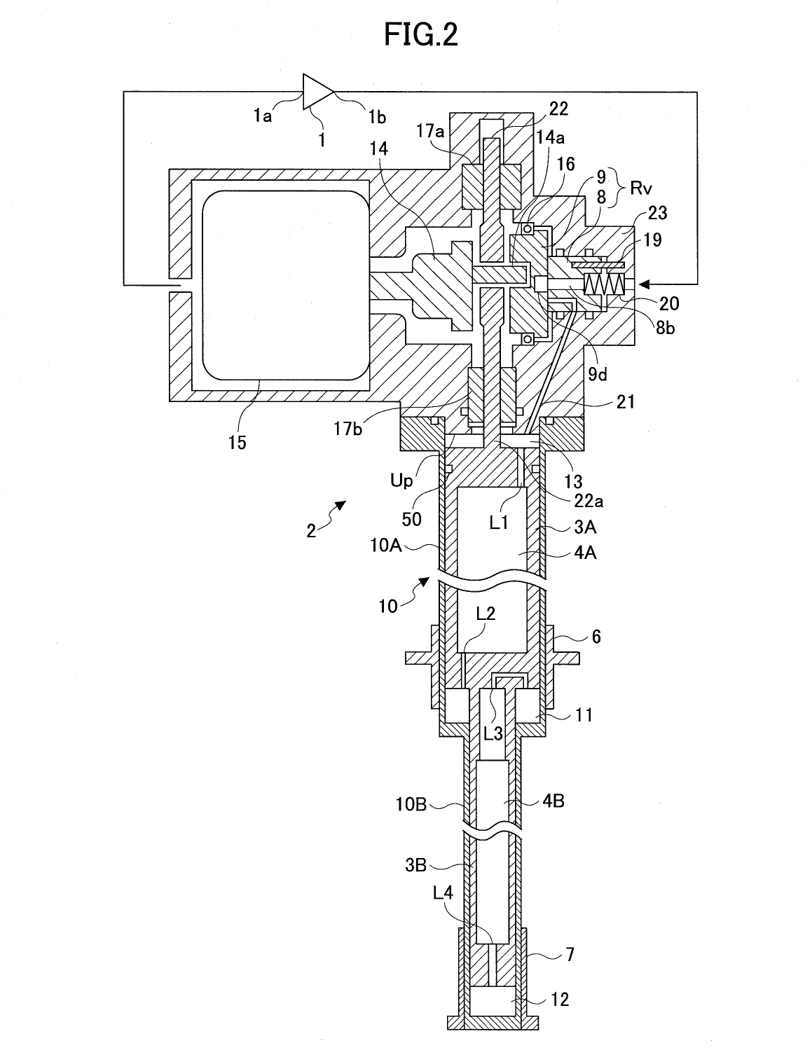

FIG. 2 is a cross-sectional view of a Gifford-McMahon type refrigerator (hereinafter, referred to as a GM refrigerator) of the embodiment. The GM refrigerator of the embodiment includes a compressor 1 and a cold head 2. The cold head 2 includes a housing 23 and a cylinder unit 10. The compressor 1 suctions the refrigerant gas from an intake port 1a, compresses the suctioned refrigerant gas, and discharges as a high pressure refrigerant gas from a discharge port 1b. The refrigerant gas as a working fluid may be a helium gas.

The cylinder unit 10 has a two stage structure including a first stage cylinder 10A and a second stage cylinder 10B. The second stage cylinder 10B is narrower than the first stage cylinder 10A. A first stage displacer 3A is inserted in the first stage cylinder 10A, and a second stage displacer 3B is inserted in the second stage cylinder 10B so that the first and second stage displacers 3A and 3B can reciprocate in axial directions of the first and second stage cylinders 10A and 10B, respectively.

The first stage displacer 3A and the second stage displacer 3B are mutually connected by a joint mechanism (not illustrated). A regenerative material 4A is provided inside the first stage displacer 3A. A regenerative material 4B fills the inside of the second stage displacer 3B. Further, gas passages L1 to L4 are formed in the first and second stage displacers 3A and 3B in order to make the refrigerant gas pass through the gas passages L1 to L4.

A first stage expansion chamber 11 is formed on an end portion on the side of the second stage cylinder 10B inside the first stage cylinder 10A. A second expansion chamber 12 is formed on an end portion opposite to the side of the first stage cylinder 10A of the second stage cylinder 10B.

An upper chamber 13 and the first stage expansion chamber 11 are connected via the gas passage L1, a first stage regenerative material chamber filled with the regenerative material 4A, and the gas passage L2. The first stage expansion chamber 11 and the second stage expansion chamber 12 are connected via the gas passage L3, a second stage regenerative material chamber filled with the regenerative material 4B, and the gas passage L4.

A cooling stage 6 is provided at a position substantially corresponding to the first stage expansion chamber 11 on the outer peripheral surface of the first stage cylinder 10A. A cooling stage 7 is provided at a position substantially corresponding to the second stage expansion chamber 12 on the outer peripheral surface of the second stage cylinder 10B.

A sealing unit 50 is arranged in the vicinity of an end of the outer peripheral surface of the first stage displacer 3A on the side of the upper chamber 13. The sealing unit 50 seals a gap between the outer peripheral surface and the inner peripheral surface of the cylinder 10A.

The first stage displacer 3A is connected to an output shaft 22a of a scotch yoke 22 forming a transforming mechanism between rotation and reciprocation. The scotch yoke 22 is movably supported in axial directions of the displacers 3A and 3B by a pair of slide bearings 17a and 17b fixed to the housing 23. Gas tightness is secured in a sliding unit by the slide bearing 17b to thereby separate the space inside the housing 23 and the upper chamber 13.

A motor 15 is connected to the scotch yoke 22. The rotation of the motor 15 may be transformed into the reciprocation by a crank 14 and the scotch yoke 22. The reciprocation is transmitted to the first stage displacer 3A. Thus, the first stage displacer 3A reciprocates inside the first stage cylinder 10A, and the second stage displacer 3B reciprocates inside the second stage cylinder 10B.

When the displacers 3A and 3B move upward in FIG. 2, the capacity of the upper chamber 13 decreases and the capacities of the first and second expansion chambers 11 and 12 increase. When the displacers 3A and 3B move downward in FIG. 2, the capacity of the upper chamber 13 increases and the capacities of the first and second expansion chambers 11 and 12 decrease. Along with variations of the capacity of the upper chamber 13 and the capacities of the first and second expansion chambers 11 and 12, the refrigerant gas moves through the gas passages L1 to L4.

When the refrigerant gas passes through the regenerative materials 4A and 4B filling the displacers 3A and 3B, heat is exchanged among the refrigerant gas and the regenerative materials 4A and 4B. With this, the regenerative materials 4A and 4B are cooled by the refrigerant gas.

A rotary valve RV is provided between the intake port 1a and the discharge port 1b of the compressor 1 in a gas passage (a route) of the refrigerant gas. More specifically, the rotary valve RV is arranged among the intake port 1a, the discharge port 1b, and the upper chamber 13 in the gas passage (the route) of the refrigerant gas. The rotary valve RV has a function of switching the gas passage (the route) of the refrigerant gas. Specifically, the rotary valve RV is provided to switch to a first mode or a second mode. The first mode is to introduce the refrigerant gas discharged from the discharge port 1b of the compressor 1 into the upper chamber 13. The second mode is to introduce the refrigerant gas inside the upper chamber 13 into the intake port 1a of the compressor 1.

The rotary valve RV includes a valve body 8 and a valve plate 9. The valve plate 9 may be made of, for example, an aluminum alloy. The valve body 8 may be made of, for example, ethylene tetrafluoride. The valve body 8 and the valve plate 9 include flat surfaces, respectively. The flat surfaces of the valve body 8 and the valve plate 9 mutually contact face to face. A thin film made of a hard material such as diamond-like carbon (DLC) can be formed on at least one of the sliding surfaces of the valve body 8 and the valve plate 9 in order to reduce friction occurring on the sliding surfaces and improve wear resistance.

The valve plate 9 is supported by a rotational shaft bearing 16 inside the housing 23 so that the valve plate 9 is rotatable. An eccentric pin 14a of the crank 14 drives the scotch yoke 22 by the rotation of the crank 14. When the eccentric pin 14a revolves around the rotational shaft, the valve plate 9 is driven to rotate. The valve body 8 is pushed against the valve plate 9 and fixed so as not to rotate.

A coil spring 20 presses the valve body 8 so that the valve body 8 is not separated from the valve plate 9 when the pressure on an ejection side becomes greater than the pressure on a suction side. The force pressing the valve body 8 to the valve plate 9 is determined not only by the spring force of the coil spring 20 but also by differential pressure acting on the valve body 8 between pressure of the refrigerant gas on the suction side and pressure of the refrigerant gas on the ejection side.

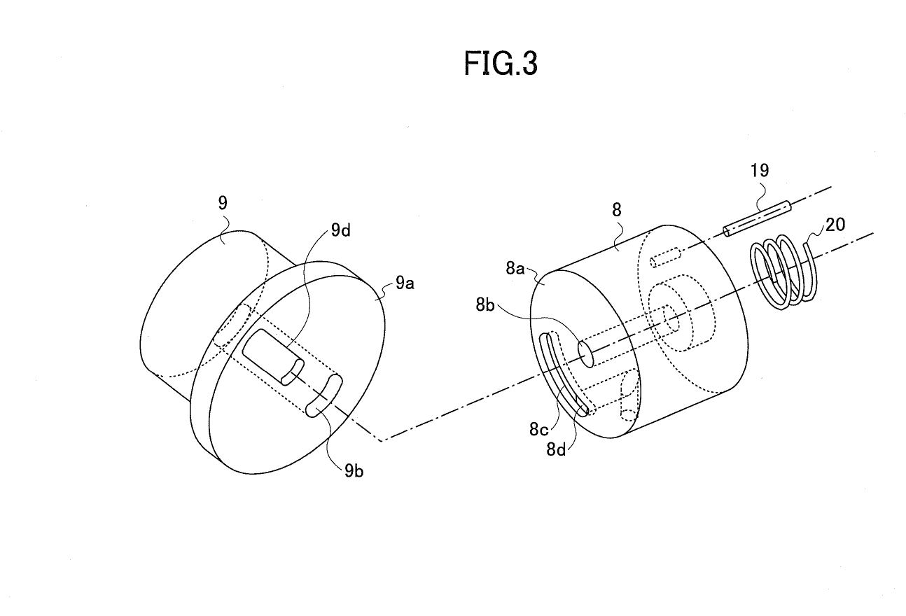

FIG. 3 is an exploded perspective view of the rotary valve RV. A flat sliding surface 8a of the valve body 8 in a cylindrical shape contacts a flat sliding surface 9a of the valve plate 9. Thus, a surface contact between the flat sliding surface 8a of the valve body 8 and the flat sliding surface 9a of the valve plate 9 occurs. A gas passage 8b penetrates the valve body 8 along a central axis of the valve body 8. Said differently, one end of the gas passage 8b opens on the sliding surface 8a. The other end of the gas passage 8b is connected to the discharge port 1b of the compressor 1 illustrated in FIG. 2. The gas is supplied from the discharge port 1b of the compressor 1 to the gas passage 8b of the valve body 8.

An arc-like recess 8c is formed on the sliding surface 8a of the valve body 8 along an arc around the center axis of the valve body 8. An end of a gas passage 8d formed inside the valve body 8 opens on a bottom surface of the arc-like recess 8c. The other end of the gas passage 8d opens on the outer peripheral surface of the valve body 8 and communicates with the upper chamber 13 via a gas passage 21 formed in the housing 23 illustrated in FIG. 2.

A recess 9d is formed on the sliding surface 9a of the valve plate 9. The recess 9d is elongated on the sliding surface 9a along a radius direction from the center axis of the valve plate 9. When the valve plate 9 rotates, an end portion of the recess 9d may partially overlap the arc-like recess 8c to cause the gas passage 8b and the gas passage 8d to mutually communicate via the recess 9d.

A gas passage 9b arranged parallel to a rotary shaft penetrates the valve plate 9. The gas passage 9b is opened at substantially the same position as that of the arc-like recess 8c on the sliding surface 8a of the valve body 8. When the opening of the gas passage 9b partially overlaps the arc-like recess 8c as a result of the rotation of the valve plate 9, the gas passage 8d communicates with the gas passage 9b. The other end of the gas passage 9b communicates with the intake port la of the compressor 1 via a cavity inside the housing 23 illustrated in FIG. 2. The refrigerant gas is ejected from the gas passage 9b of the valve plate 9 to the intake port la of the compressor 1.

When the gas passage 8b communicates with the gas passage 8d via the arc-like recess 8c, the refrigerant gas sent from the compressor 1 is sent inside the upper chamber 13 via the rotary valve RV. When the gas passage 8d communicates with the gas passage 9b, the refrigerant gas inside the upper chamber 13 is recovered by the compressor 1. Therefore, when the valve plate 9 is rotated, introduction (suction) of the refrigerant gas into the upper chamber 13 and recovery (ejection) of the refrigerant gas from the upper chamber 13 are repeated.

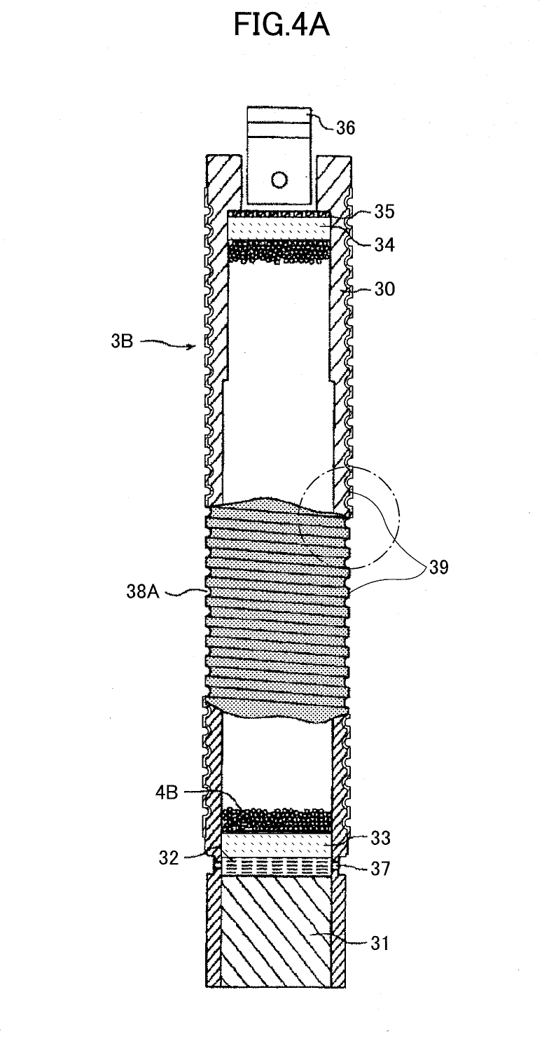

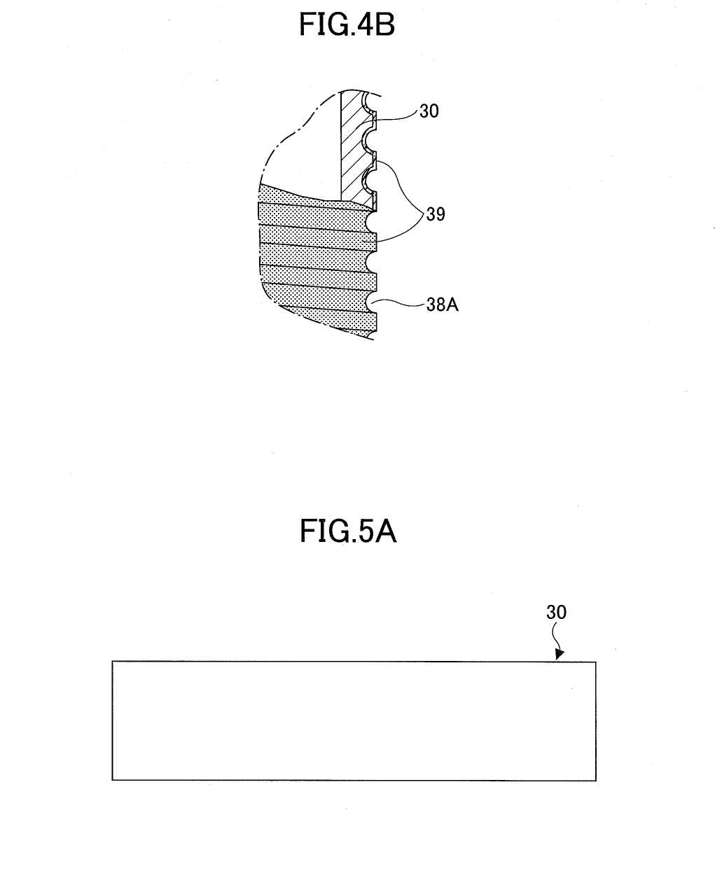

FIG. 4A is a partial cross-sectional view of the second stage displacer 3B. FIG. 4B is an enlarged view of the circle indicated by a dot chain line in FIG. 4A. The base body of the second stage displacer 3B is a cylindrical member 30. An upper end and a lower end of the cylindrical member 30 are opened. A lid 31 is inserted in the lower end of the cylindrical member 30 and adhered to the cylindrical member 30. The cylindrical member 30 is made of stainless steel, and the lid 31 can be made of a phenol resin including fabric. In the cylindrical member 30, woven metallic wires 32 are provided on the lid 31, and a felt plug 33 is provided on the woven metallic wires 32.

The regenerative material 4B fills the inside of the second stage displacer 3B on the felt plug 33. The regenerative material 4B may be, for example, small lead spheres or a magnetic regenerative material. The refrigeration capacity can be enhanced by using the regenerative material. A felt plug 34 is arranged on the regenerative material 4B, and a perforated metal (punching metal) 35 is provided on the felt plug 34.

An opening 37 is provided at a vertical position of the woven metallic wire 32 on a side wall of the cylindrical member 30. A groove is formed at a position above the opening 37 on the outer peripheral surface of the cylindrical member 30. Within the embodiment, the groove is a helical groove 38A in a helical shape for connecting the vertical position of the opening 37 to the upper end. The number of the helical groove 38A may be one. The helical groove 38A collaborates with the inner surface of the cylinder 10B to form a helical gas passage.

Further, the outer diameter of the cylindrical member 30 lower than the opening 37 is slightly smaller than the outer diameter of the cylindrical member 30 upper than the opening 37. Therefore, a gap is formed between the cylindrical member 30 and the second stage cylinder 10B at the portion lower than the opening 37. The gap and the opening 37 form the gas passage L4 connecting the inside of the cylindrical member 30 and the expansion space 12 illustrated in FIG. 2 (for convenience, the gas passage L1 is illustrated so as to vertically penetrate the lid 31).

In the second stage displacer 3B, if the refrigerant gas flows into the gap between the inner peripheral surface of the cylinder 10B and the outer peripheral surface of the displacer 3B, the refrigerant gas flows along the helical groove 38A. Heat is exchanged between the refrigerant gas and the regenerative material 4B via the cylindrical member 30. At this time, by forming the helical groove 38A on the surface of the cylindrical member 30, the refrigerant gas flows through the long passage along the helical groove 38A. Therefore, sufficient heat exchange becomes possible. Thus, the heat exchange is securely performed to thereby prevent the refrigeration capacity from being degraded. Thus, cooling efficiency of the GM refrigerator can be improved.

Next, the outer peripheral surface of the second stage displacer 3B installed in the GM refrigerator of the embodiment may be explained.

As described, the helical groove 38A is formed on the outer periphery of the second stage displacer 3B. Within the embodiment, a sealing film 39 is formed at least on a region where the helical groove 38A is formed on the outer peripheral surface of the cylindrical member 30 in its longitudinal direction. The sealing film coats not only the outer peripheral surface of the cylindrical member 30 but also the inside of the helical groove 38A.

The sealing film 39 is provided to enhance the sealing performance of a gap between the second stage displacer 3B and the inner wall of the second stage cylinder 10B. Within the embodiment, a fluorine contained resin which has high thermal and mechanical properties and good sliding capability is used as the sealing film 39. Specifically, Teflon (“Teflon” is a registered trademark) is used as the sealing film 39.

As described above, if the sealing film 39 on the surface of the second stage displacer 3B is thick, variation may occur in the clearance (gap) between the second stage displacer 3B and the inner wall of the second stage cylinder 10B due to a difference of the coefficients of thermal expansion of the sealing film 39 and the second stage cylinder 10B to thereby lower the refrigeration capacity. Within the embodiment, the film thickness of the sealing film is set to be 5 μm or greater and 50 μm or smaller. By thinning the sealing film 39, it is possible to prevent the variation of the clearance (gap), caused by the difference of the coefficients of thermal expansion between the sealing film 39 and the second stage cylinder 10B to thereby prevent decrement of the cooling efficiency.

However, if the film is simply made thin, the strength of the sealing film may be lowered. Therefore, the sealing film coated on the cylindrical member 30 may be peeled off the cylindrical member 30 when the helical groove 38 is mechanically cut. Therefore, within the embodiment, this problem is solved by forming the sealing film 39 after forming the helical groove 38A.

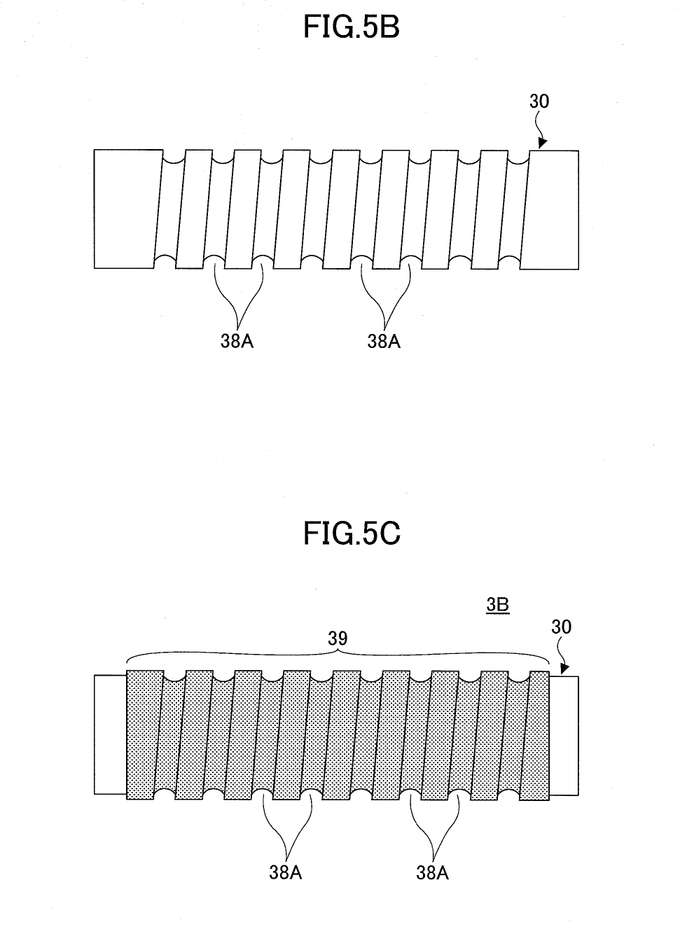

Next, referring to FIGS. 5A to 5C, a method of forming the sealing film 39 on an entire area of the helical groove 38A of the cylindrical member 30 in its longitudinal direction is described.

In order to form the cylindrical member 30 of the embodiment, the cylindrical member 30 being the base material of the displacer 3B illustrated in FIG. 5A is prepared. This cylindrical member 30 is made of stainless steel. The cylindrical member 30 has a cylindrical shape inside which a space for accommodating the regenerative material 4B or the like is formed.

Within the embodiment, a helical groove cutting process of cutting the helical groove 38A on the outer peripheral surface of the cylindrical member 30 is performed. The helical groove 38A may be cut using an ordinary method. The cylindrical member 30 is mounted on machining equipment such as a lathe turning machine to cut the helical groove 38A. Since the ordinary cutting process can be used to cut the helical groove 38A, the processing cost does not increase. FIG. 5B illustrates the cylindrical member 30 formed with the helical groove 38A.

After completing the helical groove cutting process, a sealing film forming process for coating the sealing film 39 on cylindrical member formed with helical groove 38A is performed. In the sealing film forming process, a fluorine contained resin to be the sealing film 39 is coated on an area including the helical groove 38A on the outer peripheral surface of the cylindrical member 30 as illustrated in FIG. 5C.

A method of coating the sealing film on the cylindrical member 30 is a coating method or a plating method. The film thickness of the sealing film 39 is set to be 5 μm or greater and 50 μm or smaller as described above. However, the film thickness can be easily controlled by managing a time for coating the sealing film 39 or a time for plating the sealing film 39. Since the sealing film 39 is thinned as described above, it is preferable to use the coating method or the plating method.

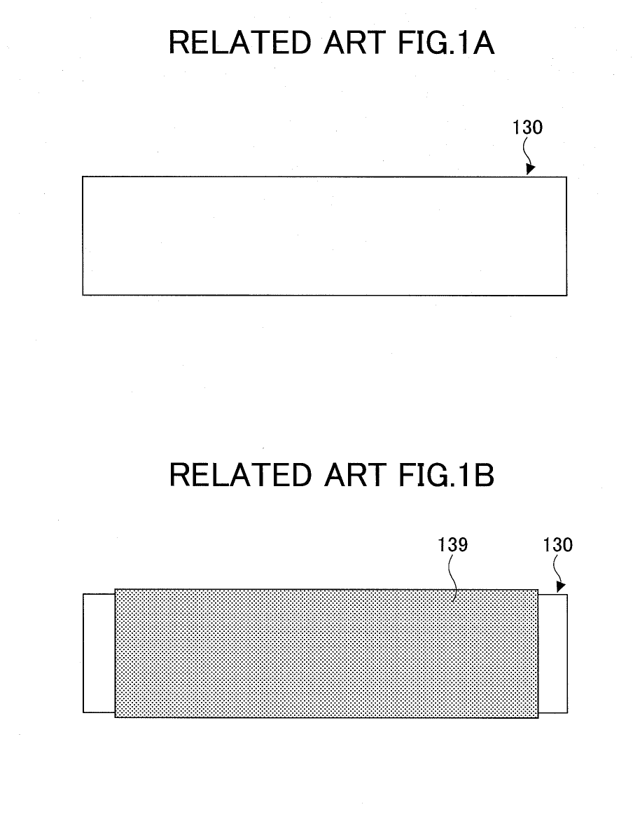

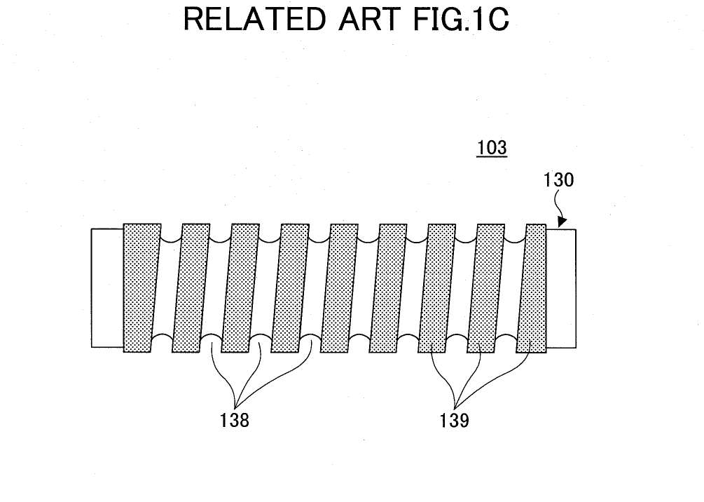

After the helical groove cutting process is completed, the sealing film 39 is coated on not only the outer peripheral surface of the cylindrical member 30 but also the inside of the helical groove 38A in the sealing film forming process. Therefore, unlike the method of forming the helical groove 138 after coating the sealing film 139 illustrated in FIGS. 1A to 1C, the sealing film 39 does not peel off the cylindrical member 30 in the manufacturing method of the displacer 3B of the embodiment.

Further, in the method of forming the helical groove 138 after coating the sealing film 139 illustrated in FIGS. 1A to 1C, the sealing film 139 is formed only on the auger of the helical groove 138, and a portion of the sealing film 139 corresponding to the inside of the helical groove 138 is removed at a time of cutting the helical groove 138. Within the embodiment, the sealing film 39 is coated entirely on the helical groove 38A, not only on the auger of the helical groove 38A but also the inside of the helical groove 38A. Said differently, the sealing film 39 is not separated by the helical groove 38A to coat the entire area of the helical groove 38A of the cylindrical member 30 in its longitudinal direction. Therefore, the sealing film 39 is firmly fixed to the cylindrical member 30 thereby preventing the sealing film from peeling off the cylindrical member 30.

As described, in the displacer 3B of the embodiment, it is possible to prevent the sealing film 39 from peeling off the cylindrical member 30 even if the sealing film 39 is thinned to be 5 μm or greater and 50 μm or smaller.

Therefore, it is possible to prevent the clearance (the gap) between the sealing film 39 and the inner wall of the second stage cylinder 10 from varying due to the thin sealing film 39. Thus, the refrigerant gas is prevented from leaking from the clearance (the gap) between the sealing film 39 and the inner wall of the second stage cylinder 10. Further, it is possible to securely prevent the sealing film 39 from peeling off the cylindrical member 30 to thereby prevent the refrigerant gas from leaking from the peeled portion in the structure illustrated in FIG. 1C. Thus, it is possible to prevent the refrigerant gas from leaking from the gap between the second stage displacer 3B and the second stage cylinder 10B thereby securely preventing the degradation of the refrigeration capacity of the GM refrigerator.

Within the embodiment, the film thickness of the sealing film is set to be 5 μm or greater and 50 μm or smaller. If the film thickness is smaller than 5 μm, the strength of the sealing film 39 is weakened. Then, the sealing film having the film thickness smaller than 5 μm may peel off the cylindrical member 30 by the reciprocation of the second stage displacer 3B inside the second stage cylinder 10B. If the film thickness is greater than 50 μm, the clearance (the gap) between the sealing film 39 and the inner wall of the second stage cylinder 10 may vary.

Next, another modified embodiment of the present invention is described.

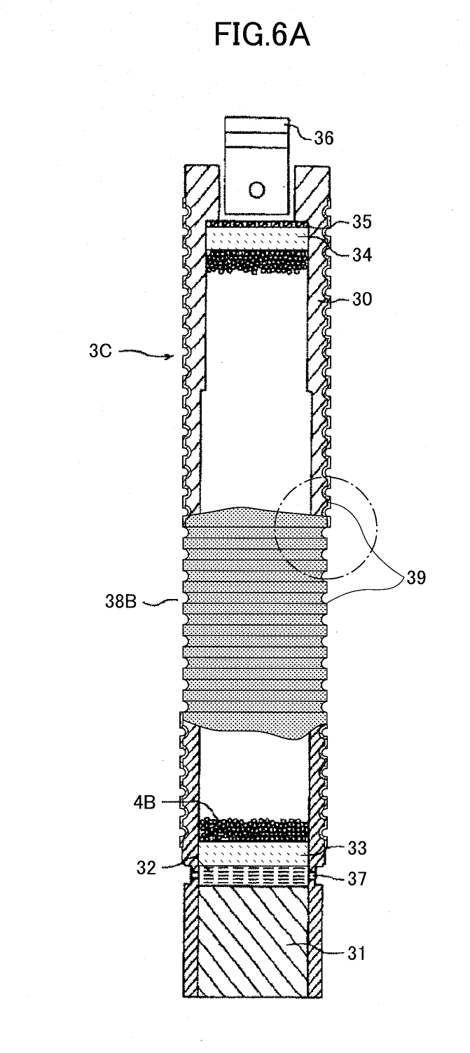

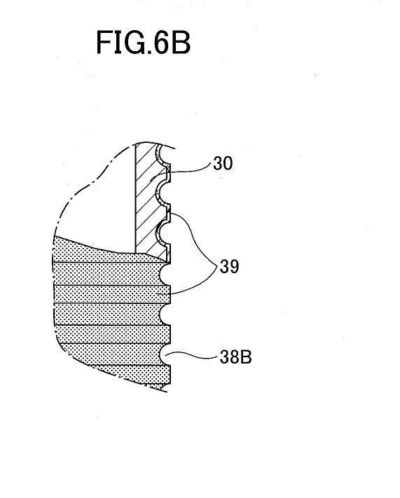

FIGS. 6A and 6B illustrate a modified example of the second stage displacer 3B illustrated in FIGS. 4A and 4B. FIG. 6A is a partial cross-sectional view of a second stage displacer 3C of the modified example. FIG. 6B is an enlarged view of the circle indicated by a dot chain line in FIG. 6A. Referring to FIGS. 6A and 6B, the same reference symbols are attached to portions corresponding to those attached to FIGS. 2 and 4A and 4B, and description of the portions is omitted.

Referring to the second stage displacer 3B illustrated in FIGS. 4A and 4B, the one helical groove 38 is formed on the outer periphery of the cylindrical member 30 and extends in a longitudinal direction of the cylindrical member 30. Within the modified example, plural grooves 38B (hereinafter, referred to as an annular groove 38B) are formed as illustrated in FIGS. 6A and 6B.

These annular grooves 38B are independent of each other unlike the one helical groove 38A. The annular grooves 38B are arranged mutually in parallel and in a longitudinal direction of the cylindrical member 30.

Within the modified example, even though the plural helical grooves 38 are formed in the cylindrical member 30, it is possible to highly efficiently exchange heat in comparison with a displacer having no groove. Therefore, it is possible to prevent the refrigeration capacity from degrading.

At this time, a connection groove may be formed between the adjacent annular grooves 38B to enable the refrigerant gas flowing between the adjacent annular grooves 38B. With this structure, it is possible to further enhance the efficiency of heat exchange between the refrigerant gas and the second stage displacer 3C.

Further, within the modified example, the sealing film 39 is formed in an area where the annular grooves 38B are formed on the outer peripheral surface of the cylindrical member 30. The sealing film 39 coats not only the outer peripheral surface of the cylindrical member 30 but also the insides of the annular grooves 38B. The annular grooves 38B can be processed by a method similar to that described with reference to FIGS. 5A to 5C. The difference of the processes is whether the helical groove is formed or the annular grooves are formed. The thickness of the sealing film 39 is 5 μm or greater and 50 μm or smaller in a manner similar to the second stage displacer 3B.

Therefore, by using the second stage displacer 3C of the modified example, the refrigeration capacity of a GM refrigerator can be securely prevented from degrading by using the second stage displacer 3C of the modified example in a manner similar to the embodiment illustrated in FIGS. 2, 6A and 6B.

Although the Gifford-McMahon (GM) type refrigerator having the two stages is applied to the embodiment and the modified example as described above, the GM type refrigerator may not be limited to the two stage type and may also be a single stage type or a multiple stage type.

Further, within the embodiment, the helical groove 38A and the sealing film 39 are provided in the second stage displacer 3B. However, the helical groove 38A and the sealing film 39 may also be provided to the first stage displacer 3A in a structure similar to the second stage displacer 3B.

Thus, the refrigerant gas can be prevented from leaking and the refrigeration capacity can be prevented from degrading with the embodiment and the modified example.

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of superiority or inferiority of the embodiments. Although the displacer, the manufacturing method of the displacer and the regenerative type refrigerator have been described in detail, it should be understood that the various changes, substitutions, and alterations could be made hereto without departing from the spirit and scope of the invention.

What is claimed is:

1. A displacer to be inserted into a cylinder to expand a compressed working fluid inside the cylinder by reciprocation of the displacer inside the cylinder, the displacer comprising:
a cylindrical member; and
a regenerative material included inside the cylindrical member,
wherein a groove is formed on an outer peripheral surface of the cylindrical member, the outer peripheral surface facing the cylinder, and
a sealing film is continuously formed on the outer peripheral surface and the groove over an area where the groove is formed in a longitudinal direction.

2. The displacer according to claim 1,
wherein the groove is a helical groove formed on the outer peripheral surface and extending in the longitudinal direction on the cylindrical member.

3. The displacer according to claim 1,
wherein the sealing film has a thickness of 5 μm or greater and 50 μm or smaller.

4. The displacer according to claim 1,
wherein the sealing film is made of a fluorine contained resin.

5. A manufacturing method of a displacer comprising:
cutting a groove on an outer peripheral surface of a cylindrical member; and
coating a sealing film continuously on the outer peripheral surface and the groove over an area where the groove is formed in a longitudinal direction of the cylindrical member after the cutting the groove.

6. The manufacturing method according to claim 5,
wherein the groove is a helical groove formed on the outer peripheral surface and extending in the longitudinal direction on the cylindrical member.

7. The manufacturing method according to claim 5,
wherein the groove is cut by a machine.

8. The manufacturing method according to claim 5,
wherein the sealing film is formed by a coating method or a plating method.

9. The manufacturing method according to claim 5,
wherein the sealing film is made of a fluorine contained resin.

10. A regenerative type refrigerator comprising:
a cylinder into which a compressed working fluid is supplied;
the displacer according to claim 1;
a transforming mechanism for transforming rotation applied from an outside to reciprocation of the displacer,
wherein the displacer reciprocates inside the cylinder to expand the compressed working fluid inside the cylinder so as to generate cold thermal energy.
